(19) United States
(12) Patent Application Publication
(10) Pub. No.: US 2004/0021313 A1
(43) Pub. Date: Feb. 5, 2004

(54) Tag marking

(76) Inventors: Michael Stuart Gardner, Auckland 5 (NZ); Roy Victor Bladen, Auckland 5 (NZ)

Correspondence Address: HENRICKS SLAVIN AND HOLMES LLP, SUITE 200, 840 APOLLO STREET, EL SEGUNDO, CA, 90245

(21) Appl. No.: 10/432,304

(22) PCT Filed: Nov. 21, 2001
(86) PCT No.: PCT/NZ01/00261

(30) Foreign Application Priority Data
Nov. 21, 2000 (NZ) 508331
Dec. 13, 2000 (NZ) 508861

(51) Int. Cl. B42D 15/00

(52) U.S. Cl. 283/81

(57) ABSTRACT

A plastic product such an animal ear tag (1) is laser marked with indicia (2). The contrast between the indicia (2) and the surrounding surface of the tag (1) is enhanced by the heated of the indicia following laser marking to a temperature at which the indicia and the surrounding surface have melted. In the preferred embodiment the indicia (2) is provided as a raised surface (3) and with a plurality of spaced apart peaks (4) with gaps (6) therebetween. The heating of the tag (1) is preferably by the application of a hot plate to the indicia surface of the tag and simultaneaouly or subsequently to the non-indicia surface of the tag.

### FIELD OF THE INVENTION

The present invention relates to improvements and relating to tag marking and more particularly to tags which are marked with the relevant indicia by the use of lasers.

### BACKGROUND OF THE INVENTION

For simplicity, the present invention will be described in respect of animal ear tags. However, it will be appreciated that the present invention has use in respect of ear tags or other identification items such as bracelets, labels or the like whether for use by animals, persons, or attachment to objects or the like.

The use of lasers to provide a permanent method of marking of plastic ear tags, and in particular tags of polyurethane, and polyamides (nylon), has been approved at least by the New Zealand authorities. Such laser marking provides a permanence extending at least for around 5 to 7 years.

To date, in moulding a thermoplastic polyurethane tag a laser additive will generally be included in the material mixture. Subsequently, when laser light is applied to the moulded tag, using a special laser marking machine, the laser additive will react with the laser light changing the colour of the tag material to a depth of around 0.1 mm typically.

It has been found that often the surface of the tag may be burnt trying to achieve a contrast of the marking or indicia to the base colour of the tag. Such burning is undesirable as it may destroy the polyurethane material which will affect its properties and this can limit the life of the tag.

To the present time, therefore, laser marking has typically been of a grey colour and this has been a disadvantage in being relatively non-distinctive as compared to a typical black marking which is achieved using a standard foil printed tag.

An associated problem is that the Regulatory Authorities at least in New Zealand are requiring the use of bar codes at least as part of the indicia. As such bar codes are not achievable using foil printing, it becomes even more important to utilise laser marking by which bar codes are able to be printed. Although ink jet printing is another possibility, this has a problem of not being permanent. Additionally, hot foil marked tags are generally not permanent and are typically only guaranteed for one year. A particular problem with hot foil marked tags is that the marking easily abrades from the tag surface.

In order to improve the contrast of existing laser created indicia, it has been suggested that foil printing or ink jet printing could be used over the laser mark. However, this results in a tag surface which is not smooth, is not easy to clean and/or attracts surface dirt.

### OBJECTS OF THE INVENTION

It is therefore an object of the present invention to provide an improved laser marked tag (as herein defined) and/or a method of making such a tag which will overcome or at least ameliorate problems in laser marked and other tags available to the present time, or which at least will provide the public with a useful choice.

Further objects of this invention, which should be considered in all its novel aspects will become apparent from the following description.

### SUMMARY OF THE INVENTION

According to one aspect of the present invention, there is thus provided a tag incorporating indicia which has been provided by a laser in which the contrast between the indicia and the tag material has been improved by heating the tag surface to a temperature sufficient to melt the surface and the laser indicia.

Preferably, the tag is of polyurethane and the temperature is between approximately 50° C. and 500° C.

Optionally, following the heating, the tag may be quenched to prevent distortion of the tag surface.

Optionally, the quenching of the tag may be between a pair of relatively cold plate surfaces.

According to a further aspect of the present invention there is provided a tag incorporating indicia which has been provided by a laser and in which the contrast between the indicia and the tag material has been improved by the heating of the tag surface to a temperature sufficient to melt the surface and the indicia and wherein the indicia has one or more portions thereof raised above the surface and with at least one gap provided in or between the or each raised portion.

Preferably, part of the indicia material has also dispersed into the material below the surface.

Preferably the raised portion of the indicia includes a plurality of peaks and troughs defining a plurality of said gaps.

According to a still further aspect of the present invention, a method of laser marking a tag (as herein defined) includes:

(i) applying the required indicia by a laser to mark a tag surface;

(ii) heating the surface to melt the surface and the indicia and blend the material together to improve the contrast of the indicia and the material.

Preferably, the above method further includes the use of a temperature of between approximately 50° C. to 500° C.

Optionally, the above method may further include the quenching of the tag to seal the tag surface and prevent distortion of the tag surface.

Optionally, the above method may include the quenching between a pair of relatively cold plates.

Preferably, the above method includes monitoring means to monitor the heating times and temperatures to prevent the tag surface from burning or over-melting.

According to a further aspect of the present invention there is provided a method of laser marking a tag including:

(i) Applying required indicia by a laser to mark a tag surface such that at least part of the indicia is raised above a surrounding surface with at least one gap therein;

(ii) Heating the surface to melt the surface and the indicia to blend the material together to improve the contrast of the indicia and the surrounding surface.

Preferably, the method as immediately above defined disperses part of the indicia material below the surface.

According to a still further aspect of the present invention, a laser marked tag and/or a method of laser marking a tag is substantially as herein described.

Further aspects of this invention, which should be considered in all its novel aspects will become apparent from the following description given by way of example of possible embodiments of the invention given by way of example and with reference to the accompanying drawings.

### BRIEF DESCRIPTION OF THE DRAWINGS

FIG. 1: shows very diagrammatically a tag featuring laser marking according to one possible embodiment of the invention;

FIG. 2: shows very diagrammatically a female animal ear tag according to a further possible embodiment of the invention;

FIG. 3: shows a greatly enlarged view of portion A of the ear tag of FIG. 2; and

FIG. 4: shows a part cross-sectional view through the indicia portion of the tag of FIGS. 2 and 3.

### BRIEF DESCRIPTION OF POSSIBLE EMBODIMENTS OF THE INVENTION

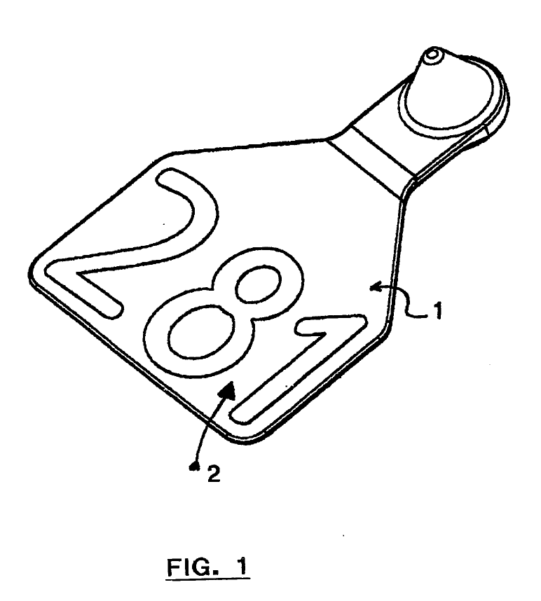

Referring to FIG. 1, a tag according to one possible embodiment of the invention is shown very diagrammatically. The tag 1, (only the female tag being shown), is shown with a typical animal ear tag indicia, which would typically identify a particular animal, by an alpha numeric code, bar code, or the like. The tag 1 is of a plastics material, typically thermoplastic polyurethane (TPU) which will have had a suitable laser additive included in the plastics material when moulded.

Indicia 2 will then have been applied by use of a suitable laser marking machine whereby the laser additive will have reacted to the laser light, typically changing the colour of the marking to a grey colour to a depth of around 0.1 mm, this grey colour being substantially non-distinctive on many colours.

Following the laser marking of the indicia, the present invention heats the tag, preferably firstly on the side of the indicia, to a temperature of between 50° C. to 500° C. approximately, the temperature and its time of application being sufficient to melt the surface of the tag and the laser marking and then the material together, this providing a distinctive almost black colour to the mark. Optionally heat could be applied to both sides of the tag 1 simultaneously.

However a lesser heat input may be required for the non-indicia side of the tag 1. The heat input on this side is intended to flatten the tag and to make the appearance replicate that on the indicia side. The total heat input is controlled by the temperature used, the pressure applied, and its time of application.

Preferably the heating of the tag 1 may be by pressing a hot plate, or a pair of hot plates, against the surface of the tag 1. Alternatively a hot fluid, such as a gas may be applied to the surface.

Following the heating, the tag 1 may, optionally, In one embodiment, be quenched suitably between two polished cold plates. This quenching will seal the surface and prevent the distorion of the tag.

Suitable monitoring means will be provided to monitor the dwell times, plate pressure, and the temperatures in order to prevent the tag surface from burning or over-melting.

It has been found that following the application of the heating a smooth polished surface is achieved. Such a smooth polished surface has the added benefit of readily shedding surface dirt.

It has been further found that heating the tag 1 with the appropriate heat input may turn the laser marking almost black so as to provide a substantial contrast between the tag colour and the indicia. It has also been found that the base tag colour has by the heating and/or quenching appeared to brighten, which again, enhances the contrast.

In further trial and experimentation, the applicant has, however, found that the final quality of the laser marking may be largely determined by the characteristics of the initial laser mark, and in particular, in providing the initial laser mark with at least a partially raised surface. In a further embodiment the present invention is able to provide even greater contrast and greater longevity when compared with a standard laser mark.

By raising the tag marking indicia above the general tag surface and preferably also dispersing the mark into the tag material below the surface this can provide a mark most suitable for enhancement with the process identified below. It has been found that the raising of the mark above the general surface of the order of 0.1 mm with about an additional 0.1 mm below the surface may be suitable in at least one embodiment. This may be achieved by a suitable pattern such as that of diagonal, circular, or vertical lines defined by spaced apart troughs or gaps between adjacent peaks. The provision of one or more gaps in the mark allows the raised material to flow across the gap(s) when subsequently heated.

It has been found that the application under pressure of a very hot plate at a temperature of 50° C. to 500° C. for a suitable time, for example above 10 ms for the lower temperature, suitably with the use of a barrier such as a PTFE barrier between the tag and the hot plate, can provide a suitable enhancing process, with the indicia being sealed flush with the tag surface, blending the peaks of the indicia and pushing more of the mark below the tag surface. The laser mark has also been found to react with the heat to turn almost black to improve its contrast with the surrounding material. It has been further found that the surface of the resultant mark may have enhanced resistance to abrasion in contrast with a standard laser marking. Any suitable surface finish can be provided whether this be smooth and glossy or patterned from a heated block with a textured finish.

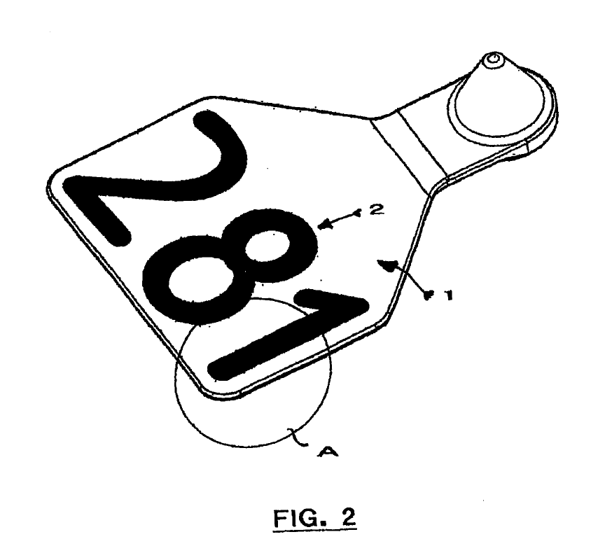

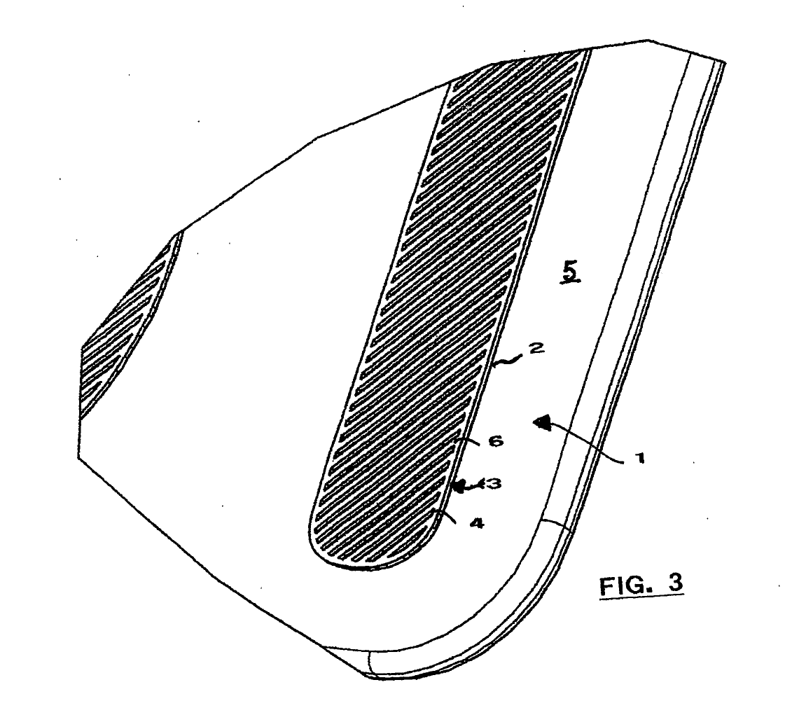

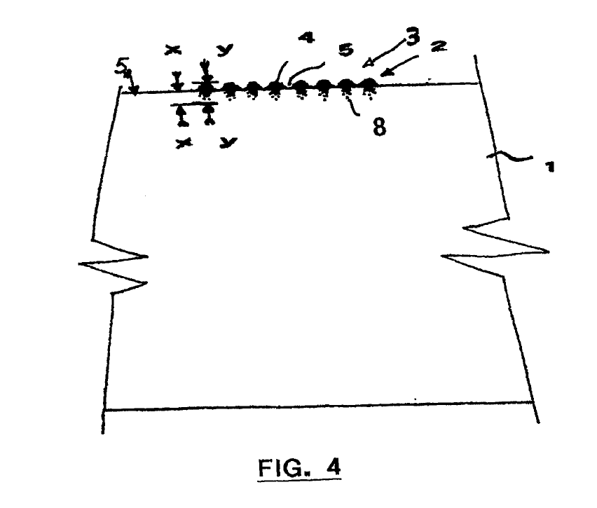

In FIG. 2, a typical female ear tag 1 is shown with numerical indicia 2. The area A is then shown enlarged in FIG. 3 with the indicia defining a generally raised area 3 and being provided as a plurality of peaks 4 with intermediate gaps or troughs 6 raised above the base surface 5 of the tag 1.With particular reference to FIG. 4, the distance between arrows X-X i.e. the depth below the surface 5 of the tag 1 could, for example, be approximately 0.1 mm, whereas the distance between Y-Y could be approximately 0.2 mm, i.e. the height of the indicia peaks 4 above the base surface 5 is approximately 0.1 mm. The gaps 6 between the peaks 4 could be of the order of 0.3 mm. These dimensions are given merely by way of example only.

Although the peaks 4 are shown in FIG. 2 providing a diagonal pattern, as mentioned previously, any type of surface or pattern may be provided as appropriate.

It has been found that this embodiment of the present invention enables a highly reactive laser additive to be used and that the enhancement of the laser marking in accordance with the present invention is able to counteract at least to some degree the inconsistencies resulting from the use of such a highly reactive laser additive.

In summary, therefore, the present invention in this embodiment provides for a laser mark which is most suitable for enhancing by heat treatment, this by the raising of the laser mark indicia above and preferably below the tag surface prior to its heat treatment and providing at least one gap in the raised mark.

Where in the foregoing description, reference has been made to specific components or integers of the invention having known equivalents then such equivalents are herein incorporated as if individually set forth.

Although this invention has been described by way of example and with reference to possible embodiments thereof, it is to be understood that modifications or improvements may be made thereto without departing from the scope of the invention as defined in the appended claims.

1. A tag incorporating indicia which has been provided on a surface of the tag by a laser in which the contrast between the indicia and the tag material has been improved by heating the tag surface to a temperature sufficient to melt the surface and the laser indicia.

2. The tag as claimed in claim 1 in which the indicia has one or more portions thereof raised above the surface of the tag and with at least one gap provided in or between the or each raised portion.

3. A tag as claimed in claim 1 or claim 2 in which the tag is of polyurethane and the temperature is between approximately 50° C. and 500° C.

4. A tag as claimed in claim 3 wherein temperature is between approximately 175° C. and 250° C.

5. A tag as claimed in any one of claims 1 to 4 wherein the heating of the tag surface is by the application under pressure of at least one hot plate to the tag surface.

6. A tag as claimed in claim 5 in which the or a said hot plate is applied first to the tag surface provided with the indicia and subsequently to an opposite surface of the tag without the indicia.

7. A tag as claimed in claim 6 in which the hot plate is applied to the surface with the indicia for a period of at least 10 ms.

8. A tag as claimed in claim 2 or any one of claims 3 to 7 when dependent on claim 2 in which the one or more raised portions of the indicia are approximately 0.1 mm above the surface on which the indicia is provided.

9. A tag as claimed in claim 8 in which the material of the tag forming the indicia penetrates to a depth of approximately 0.1 mm below said surface.

10. A tag as claimed in either of claims 8 or 9 in which a plurality of said raised portions are provided spaced apart in forming the indicia.

11. A tag as claimed in claim 10 in which the raised portions are spaced apart from each other approximately 0.3 mm.

12. A claim as claimed in claim 11 in which the raised portions are provided as a plurality of peaks with intermediate gaps or troughs.

13. A tag substantially as herein described with reference to FIG. 1 or FIGS. 2 to 4 of the accompanying drawings.

14. A method of laser marking a tag (as herein defined) including:
(I) applying the required indicia by a laser to mark a tag surface;
(ii) heating the surface to a temperature sufficient to melt the surface and the indicia to blend the material together to improve the contrast of the indicia and the material.

15. A method of laser marking a tag as claimed in claim 14 including providing the indicia raised above a surrounding surface and the indicia includes at least one gap therein.

16. A method as claimed in claim 14 or claim 15 in which the heating of the surface is by the application under pressure of at least one hot plate.

17. A method as claimed in any one of claims 14 to 16 in which the heating is first of the said surface featuring the indicia and subsequently to an opposite surface not featuring the indicia.

18. A method as claimed in any one of claims 14 to 17 in which said temperature is between approximately 50° C. to 500° C.

19. A method as claimed in claim 18 in which the temperature is between 175° C. and 250° C.

20. A method as claimed in any of claims 14 to 19 in which the tag following its heating is quenched between a pair of relatively cold plates.

21. A method as claimed in any one of claims 14 to 20, including providing a monitoring means to monitor the heating times, pressures and/or temperatures and to prevent the tag surface from burning or over-melting.

22. A method as claimed in claim 14 or claim 15 in which the heating is by means of a hot fluid applied to the tag surface.

23. A method of laser marking a tag substantially as herein described with reference to FIG. 1 or FIGS. 2 to 4 of the accompanying drawings.
